(19) United States
(12) Patent Application Publication
(10) Pub. No.: US 2012/0295635 A1
(43) Pub. Date: Nov. 22, 2012

(54) INFORMATION PROCESSING APPARATUS, MANAGEMENT METHOD, AND NON-TRANSITORY COMPUTER-READABLE MEDIUM THEREOF

(75) Inventors: Koichi YOKOTA, Yokohama (JP); Shinichi Shiotsu, Kawasaki (JP); Hiroyasu Sugano, Kita (JP); Hideki Tanaka, Kawasaki (JP); Akira Itasaki, Yokohama (JP); Daisuke Yamashita, Kawasaki (JP)

(73) Assignee: Fujitsu Limited, Kawasaki-shi (JP)

(21) Appl. No.: 13/424,836

(22) Filed: Mar. 20, 2012

(30) Foreign Application Priority Data
Mar. 30, 2011 (JP) 2011-076192

(51) Int. Cl. H04W 24/00

(52) U.S. Cl. 455/456.1

(57) ABSTRACT

There is provided an information processing apparatus including an information acquirer configured to acquire information transmitted from an access point, a movement determiner configured to determine whether or not the information processing apparatus is moving, and a registration deletion determiner configured to determine, based on the acquired information and a result determined by the movement determiner, whether to register or delete information of an location of the access point.

### CROSS-REFERENCE TO RELATED APPLICATION

This application is based upon and claims the benefit of priority of the prior Japanese Patent Application No. 2011-076192, filed on Mar. 30, 2011, the entire contents of which are incorporated herein by reference.

### FIELD

The embodiments discussed herein are related to an information processing apparatus, a management method, and a non-transitory computer-readable medium thereof.

### BACKGROUND

In the related art, positioning systems using Receive Signal Strength Indication (RSSI) exist for managing registration or deletion of location information with respect to an access point (hereinafter referred to as “AP”), or the like. To perform positioning, for example, a technique exists which receives radio waves from three APs by a terminal to acquire RSSIs, and estimates location by trilateration on the basis of the acquired RSSIs.

In location estimation systems according to the related art, location information of an AP is corrected by, for example, a user's manual operation. Therefore, to correct location information, the user is to first notice an error in the location information registered in a location estimation server. Consequently, location information is not corrected until such an error is noticed.

Accordingly, the following techniques exist in the related art: a technique in which, after radio waves from a terminal whose location is to be estimated are received by a plurality of nearby location estimation nodes, the radio waves are uploaded to a location estimation server, and the location estimation server estimates the location of the terminal; and a technique in which, for an article attached with an integrated circuit (IC) tag whose location is to be estimated, the location of the article is estimated by trilateration while varying the transmitting wave output by using a plurality of IC tag readers, and the location estimate is transmitted to a server (see, for example, Japanese Laid-open Patent Publications Nos. 2008-199360 and 2006-133128).

In the related art, a technique also exists in which an acceleration sensor is equipped to an object whose location is to be estimated, and the location of the object is estimated by using acceleration and radio RSSI (see, for example, Japanese Laid-open Patent Publication No. 2008-201569).

Further, the following techniques exist in the related art: a technique which adapts to a new radio signal frequency, modulation scheme, or positioning scheme by downloading the latest code of positioning software from a distribution server; and a technique in which, in managing article's location, when movement of an article is sensed by an acceleration sensor, radio RSSI measurement is performed, and the corresponding location is notified (see, for example, Japanese Laid-open Patent Publications Nos. 2007-163297 and 2010-33457).

### SUMMARY

According to an aspect of the invention, an information processing apparatus includes an information acquirer configured to acquire information transmitted from an access point, a movement determiner configured to determine whether or not the information processing apparatus is moving, and a registration deletion determiner configured to determine, on the basis of the acquired information and a result determined by the movement determiner, whether to register or delete information of a location of the access point.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the schematic configuration of a location estimation system according to Embodiment 1;

FIG. 2 illustrates an example of the block configuration of a terminal according to Embodiment 1;

FIG. 3 illustrates an example of the block configuration of a location estimation server according to Embodiment 1;

FIG. 4 illustrates an example of the criteria for determining whether to register/delete AP information according to Embodiment 1;

FIGS. 5A and 5B illustrate states when AP information is registered and deleted, respectively;

FIGS. 6A and 6B illustrate specific examples of registration/deletion request information and location estimation data table according to Embodiment 1;

FIG. 7 is a flowchart illustrating an example of a RSSI value variation determining process in a terminal according to Embodiment 1;

FIG. 8 is a flowchart illustrating an example of a movement determining process in a terminal according to Embodiment 1;

FIGS. 9A and 9B are each a flowchart illustrating an example of an AP information transmitting process in a terminal according to Embodiment 1;

FIG. 10 is a flowchart illustrating an example of a location information transmitting process in a location estimation server according to Embodiment 1;

FIG. 11 is a flowchart illustrating an example of an AP information registration/deletion process in a location estimation server according to Embodiment 1;

FIG. 12 is a flowchart illustrating an example of a data transmit control signal generating process in a location estimation server according to Embodiment 1;

FIG. 13 illustrates an example of the schematic configuration of a location estimation system according to Embodiment 2;

FIG. 14 illustrates an example of the block configuration of a terminal according to Embodiment 2;

FIGS. 15A to 15C illustrate specific examples of registration/deletion request information and location estimation data table according to Embodiment 2;

FIGS. 16A and 16B are each a flowchart illustrating an example of a RSSI value variation determining process in a terminal according to Embodiment 2;

FIG. 17 is a flowchart illustrating an example of a movement determining process in a terminal according to Embodiment 2;

FIGS. 18A and 18B are each a flowchart illustrating an example of an AP information transmitting process in a terminal according to Embodiment 2; and

FIG. 19 is a flowchart illustrating an example of an AP information registration/deletion process in a location estimation server according to Embodiment 2.

### DESCRIPTION OF EMBODIMENTS

### Preliminary Consideration

However, in the case of APs subject to frequent movement, such as mobile APs (for example, mobile routers) that are being shipped in increasing numbers in recent years, their location information is not immediately corrected. Thus, it is not possible to use mobile APs as location estimation APs.

That is, to correct location information of an AP, the user is to first notice an error in the location information sent from a server or the like. Location information is not corrected until then. Moreover, for a location estimation server to learn accurate location information, a large number of pieces of registration/correction information are to be accumulated. Thus, it takes time to acquire location information with high accuracy.

Japanese Laid-open Patent Publications Nos. 2008-199360, 2006-133128, 2008-201569, 2007-163297, and 2010-33457 mentioned above neither discuss nor suggest a configuration or the like for solving the above-mentioned problem.

Accordingly, it is preferable to facilitate registration and deletion of location information of an AP, and to improve the accuracy of location information.

Hereinafter, the embodiments are described in detail with reference to the attached drawings.

### Embodiment 1

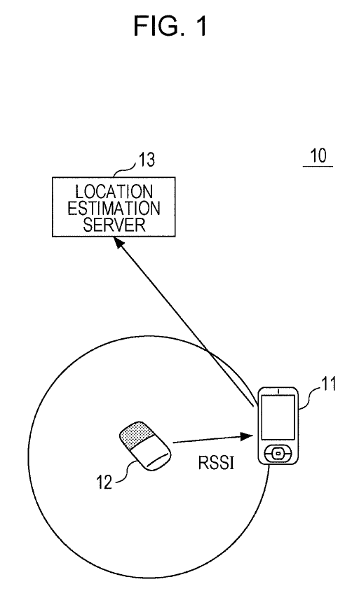

FIG. 1 illustrates an example of the schematic configuration of a location estimation system according to Embodiment 1. A location estimation system 10 illustrated as FIG. 1 has a terminal 11, an AP 12, and a location estimation server 13.

The terminal 11 receives radio waves from the AP 12, and acquires RSSI. The terminal 11 can also acquire the RSSI from the AP 12 a plurality of times at predetermined time intervals. The terminal 11 performs communication with the location estimation server 13 when the acquired RSSI meets a predetermined criterion.

Specifically, the terminal 11 performs processing such as registration of location information or the like for the AP 12 whose RSSI is being currently acquired, or deletion of already-registered AP information such as location information, to or from the location estimation server 13. Applicable examples of the terminal 11 include, but are not limited to, a portable telephone, a personal digital assistant (PDA), a notebook personal computer, an e-book terminal, a music player, a game machine, a point of sale (POS) terminal, and a radio.

The AP 12 may be, for example, a fixed AP or a mobile AP or the like that is movable. If the AP 12 is a mobile AP, the location information of the AP 12 changes with movement of the AP 12.

The location estimation server 13 registers or deletes AP information in accordance with registration or deletion information for AP information corresponding to the AP 12 obtained from the terminal 11.

That is, in Embodiment 1, whether to register or delete location information of the AP 12 is determined by using information transmitted from the AP 12, and the result of determination as to whether the terminal 11 is moving or not, thereby facilitating management of access point location information.

Specifically, in Embodiment 1, for example, if the positional relationship between the AP 12 and the terminal 11 meets a predetermined criterion, location information of the terminal 11 is regarded as location information of the AP 12 and registered to the location estimation server 13.

<Block Configuration Example of the Terminal 11>

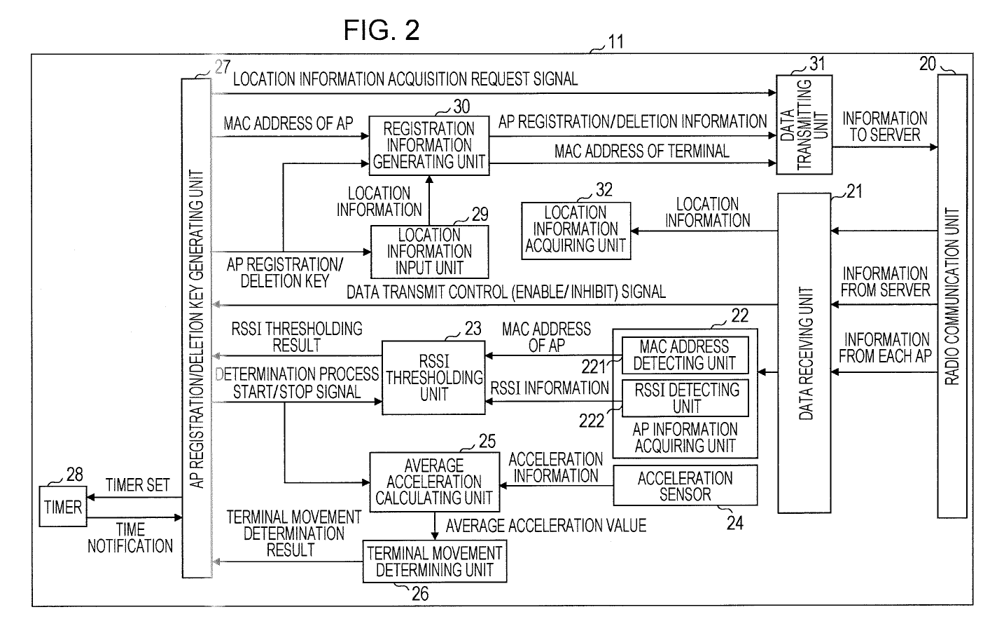

Now, a block configuration example of the terminal 11 according to Embodiment 1 is described in detail with reference to FIG. 2. FIG. 2 illustrates an example of the block configuration of the terminal 11 according to Embodiment 1. The terminal 11 illustrated as FIG. 2 has a radio communication unit 20, a data receiving unit 21, an AP information acquiring unit 22, a RSSI thresholding unit 23, an acceleration sensor 24, an average acceleration calculating unit 25, a terminal movement determining unit 26, an AP registration/deletion key generating unit 27, a timer (clocking unit) 28, a location information input unit 29, a registration information generating unit 30, a data transmitting unit 31, and a location information acquiring unit 32.

The radio communication unit 20 transmits/receives a control signal, various kinds of data, and the like to/from external equipment. The radio communication unit 20 may have, for example, an antenna or the like. The radio communication unit 20 may transmit/receive data and the like to/from external equipment by wire.

The data receiving unit 21 acquires, from a received signal obtained by the radio communication unit 20, various kinds of data from the AP 12 and various kinds of data from the location estimation server 13. The data receiving unit 21 also receives a data transmit control signal from the location estimation server 13. A data transmit control signal is, for example, an enable signal or inhibit signal that enables or inhibits a request for registration or deletion of location information of the AP 12 which is made from the terminal 11 to the location estimation server 13. The data receiving unit 21 outputs the received data transmit control signal to the AP registration/deletion key generating unit 27.

The AP information acquiring unit 22 has a media access control (MAC) address detecting unit 221, and a RSSI detecting unit 222. The MAC address detecting unit 221 detects a MAC address included in information obtained from the AP 12. The term MAC address used herein refers to, for example, a physical address for identifying the AP 12 which is uniquely assigned to each individual AP 12. The RSSI detecting unit 222 acquires RSSI corresponding to the MAC address detected by the MAC address detecting unit 221. That is, the AP information acquiring unit 22 acquires the MAC address and RSSI information of the AP 12, for example.

The RSSI thresholding unit 23 compares the RSSI obtained from the AP 12 with a preset RSSI threshold to determine whether or not to register location information of the AP 12, on the basis of a determination process start/stop signal from the AP registration/deletion key generating unit 27. The RSSI thresholding unit 23 outputs the result of thresholding using the RSSI to the AP registration/deletion key generating unit 27 together with the MAC address.

The acceleration sensor 24 is a motion sensor for determining whether the terminal 11 is stationary or non-stationary from acceleration information. That is, the acceleration sensor 24 measures acceleration information along three axes (x, y, z) of the terminal 11, and outputs the measured acceleration information to the average acceleration calculating unit 25. Also, for example, the acceleration sensor 24 measures acceleration at preset fixed time intervals, and outputs the measurements to the average acceleration calculating unit 25. Also, for example, the acceleration sensor 24 can acquire the value of gravitational acceleration “g” in a state when the terminal 11 is stationary.

In Embodiment 1, as a motion sensor for determining whether the terminal 11 is stationary or non-stationary, a sensor or the like other than the acceleration sensor 24 may be used.

The average acceleration calculating unit 25 calculates, from acceleration information periodically obtained from the acceleration sensor 24, the average of the obtained acceleration over a preset number of times or preset interval of time, on the basis of a determination process start signal or a determination process stop signal from the AP registration/deletion key generating unit 27. That is, upon receiving a determination process start signal from the AP registration/deletion key generating unit 27, the average acceleration calculating unit 25 calculates an average acceleration, and outputs the average value to the terminal movement determining unit 26. Upon receiving a determination process stop signal from the AP registration/deletion key generating unit 27, the average acceleration calculating unit 25 stops calculation of an average acceleration and output of the average acceleration to the terminal movement determining unit 26.

The terminal movement determining unit 26 compares the average acceleration value obtained from the average acceleration calculating unit 25 with a preset threshold. If the average acceleration value is equal to or greater than the threshold in a given period, the terminal movement determining unit 26 determines that terminal movement has occurred (non-stationary state), and if the average acceleration value is below the threshold, the terminal movement determining unit 26 determines that no terminal movement has occurred (stationary state). The terminal movement determining unit 26 outputs the determination result to the AP registration/deletion key generating unit 27.

The AP registration/deletion key generating unit 27 is a registration/deletion determining unit that performs processing such as registration or deletion of AP information (location information or the like) for the AP 12, on the basis of the RSSI thresholding result obtained from the RSSI thresholding unit 23 and the terminal movement determination result obtained from the terminal movement determining unit 26.

Specifically, the AP registration/deletion key generating unit 27 outputs a start signal or stop signal for a determination process performed to determine whether to register or delete location information or the like with respect to the AP 12, to the RSSI thresholding unit 23 and the average acceleration calculating unit 25. The AP registration/deletion key generating unit 27 sets the timer 28 to acquire the RSSI thresholding result and the terminal movement determination result within a predetermined interval of time, on the basis of time notification from the timer 28.

When the AP registration/deletion key generating unit 27 determines to register location information of the AP 12 on the basis of the RSSI thresholding result and the terminal movement determination result within a predetermined interval of time, the AP registration/deletion key generating unit 27 generates an AP registration key (for example, “WRITE (registration)”). When the AP registration/deletion key generating unit 27 determines to delete location information of the AP 12, the AP registration/deletion key generating unit 27 generates a deletion key (for example, “DELETE (deletion)”). The kind of each of the keys mentioned above is not limited to this, and may be, for example, a preset identification number (for example, 0 or 1) or the like.

The AP registration/deletion key generating unit 27 outputs the generated AP registration key or deletion key to the location information input unit 29 and the registration information generating unit 30.

The AP registration/deletion key generating unit 27 determines whether or not the terminal 11 is a terminal capable of AP registration/deletion, on the basis of a data transmit control (enable/inhibit) signal from the location estimation server 13. That is, by sending a data transmit control (enable/inhibit) signal to the terminal 11, the location estimation server 13 can adjust the timing at which to register or delete location information with respect to the terminal 11, or authorize only a specific terminal 11.

Also, at the time of generating AP registration information in the registration information generating unit 30, the AP registration/deletion key generating unit 27 outputs the MAC address of the AP 12 acquired from the RSSI thresholding unit 23 to the registration information generating unit 30.

Further, when acquiring the current location information of the terminal 11 from the location estimation server 13, the AP registration/deletion key generating unit 27 outputs a location information acquisition request signal for the corresponding location information to the data transmitting unit 31. In this case, in addition to the MAC address for identifying the terminal 11, the MAC address of the AP 12 located closest to the terminal 11 is also included in the location information acquisition request signal. Thus, in the location estimation server 13, by using location information registered for each MAC address of an AP registered in advance, the corresponding location information can be extracted, and the extracted location information can be transmitted to the terminal 11 that has requested for the location information.

The AP 12 located closest to the terminal 11 is determined as follows. For example, if RSSI has been acquired for only one AP, then the corresponding AP is determined to be the AP located closest to the terminal 11. If, for example, RSSIs have been acquired from a plurality of APs, the AP with the greatest RSSI is determined to be the AP located closest to the terminal 11.

When the timer 28 acquires a timer set request from the AP registration/deletion key generating unit 27, the timer 28 notifies the AP registration/deletion key generating unit 27 of the time at that instant. In Embodiment 1, the execution time of each process in the terminal 11 may be managed on the basis of time information obtained from the timer 28.

The location information input unit 29 acquires the current location information inputted by a user's manual input or the like. Examples of location information include, but are not limited to, the current latitude/longitude of the terminal 11, three-dimensional coordinate system, address information, postal code, facilities information, and building or shop name. The location information input unit 29 causes the user or the like to input location information by using, for example, an operating unit or the like provided in advance.

The location information input unit 29 enables input of location information on the basis of input of an AP registration key from the AP registration/deletion key generating unit 27, or inhibits input of location information on the basis of input of an AP deletion key from the AP registration/deletion key generating unit 27. Further, the location information input unit 29 outputs the inputted location information or the like to the registration information generating unit 30.

The registration information generating unit 30 generates registration information on the basis of an inputted AP registration/deletion key, MAC address of the AP 12, and location information. Specifically, when an AP registration key is inputted, the registration information generating unit 30 generates, for example, AP information (AP registration information) including MAC addressing information corresponding to the AP 12, location information, and the AP registration key. When an AP deletion key is inputted, the registration information generating unit 30 generates, for example, AP information (AP deletion information) including MAC addressing information corresponding to the AP 12, and the AP deletion key. If location information is included in the AP deletion information, the registration information generating unit 30 sets “null” or the like in the location information.

Further, the registration information generating unit 30 outputs the generated AP registration/deletion information and MAC address information of the terminal 11 to the data transmitting unit 31 for output to the location estimation server 13. The term MAC address used herein refers to, for example, a physical address for identifying the terminal 11 which is uniquely assigned for each individual terminal 11.

The data transmitting unit 31 outputs the AP registration/deletion information and MAC address information of the terminal 11 from the registration information generating unit 30 to the location estimation server 13 via the radio communication unit 20. The data transmitting unit 31 also outputs a location information acquisition request signal obtained from the AP registration/deletion key generating unit 27 to the location estimation server 13 via the radio communication unit 20.

The location information acquiring unit 32 acquires location information obtained as a result of transmitting the above-mentioned location information acquisition request signal to the location estimation server 13, via the data receiving unit 21.

<Block Configuration Example of the Location Estimation Server 13>

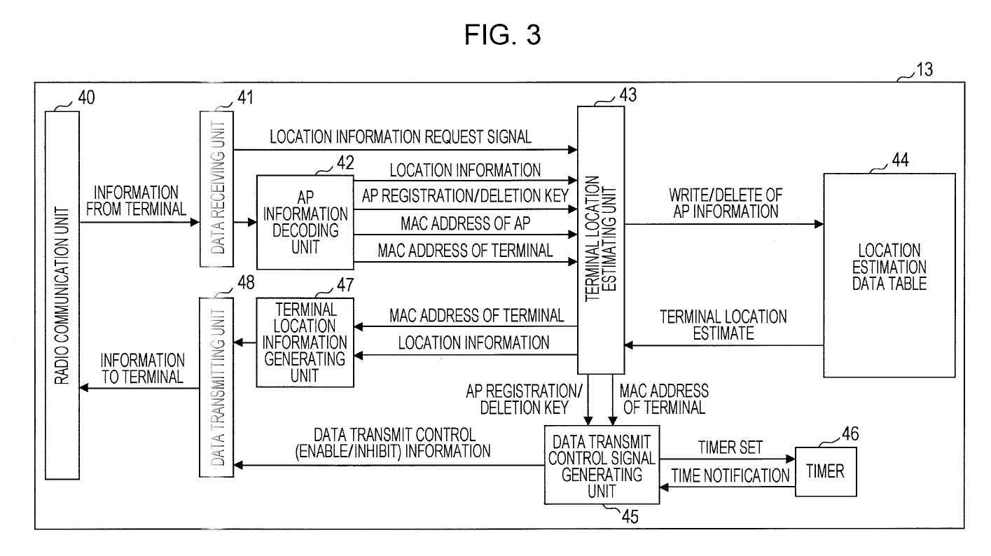

Next, a block configuration example of the location estimation server 13 according to Embodiment 1 is described in detail with reference to FIG. 3. FIG. 3 illustrates an example of the block configuration of the location estimation server 13 according to Embodiment 1. The location estimation server 13 illustrated as FIG. 3 has a radio communication unit 40, a data receiving unit 41, an AP information decoding unit 42, a terminal location estimating unit 43, a location estimation data table 44, a data transmit control signal generating unit 45, a timer (clocking unit) 46, a terminal location information generating unit 47, and a data transmitting unit 48.

The radio communication unit 40 transmits/receives a control signal, various kinds of data, and the like to/from external equipment. The radio communication unit 40 may have, for example, an antenna or the like. The radio communication unit 40 may transmit/receive data and the like to/from external equipment by wire.

The data receiving unit 41 acquires information from the terminal 11, from a received signal obtained by the radio communication signal 40. If a location information request signal is acquired from the received signal, the data receiving unit 41 outputs the location information request signal to the terminal location estimating unit 43. If another information is acquired, the data receiving unit 41 outputs the information to the AP information decoding unit 42. The other information mentioned above is, for example, the AP registration information, the MAC address information of the terminal 11, or the like obtained from the terminal 11 mentioned above.

The AP information decoding unit 42 decodes AP information from information inputted from the terminal 11. Specifically, the AP information decoding unit 42 decodes inputted information from the terminal 11, and acquires, for example, location information, a registration/deletion key for the AP 12, the MAC address of the AP 12, and the MAC address of the terminal 11. Also, the AP information decoding unit 42 outputs each piece of the decoded information to the terminal location estimating unit 43.

The terminal location estimating unit 43 refers to the location estimation data table 44 on the basis of the MAC address of the AP 12 included in a location information acquisition request signal transmitted from the terminal 11, and acquires location information corresponding to the MAC address as a location information estimate. Also, the terminal location estimating unit 43 outputs the MAC address of the terminal 11 that has made a location acquisition request, and the acquired location information to the terminal location information generating unit 47.

The terminal location information estimating unit 43 controls Write/Delete of AP information to/from the location estimation data table 44, on the basis of the location information, the AP registration/deletion key, the MAC address of the AP 12, and the MAC address of the terminal 11 obtained by the AP information decoding unit 42. Also, the terminal location information estimating unit 43 outputs the AP registration/deletion key and the MAC address of the terminal 11 to the data transmit control signal generating unit 45.

The location estimation data table 44 is a table for managing registration/deletion of AP information such as the MAC address and location information (for example, three-dimensional coordinates (X, Y, Z)) of the AP 12. The location estimation data table 44 may also accumulate information or the like other than the above-mentioned information (for example, RSSI information). A specific example of the location estimation data table 44 is described later.

The data transmit control signal generating unit 45 sets the timer 46, and is notified of time. Also, on the basis of the time acquired from the timer 46, the data transmit control signal generating unit 45 generates data transmit control (enable/inhibit) information for the terminal 11. That is, in Embodiment 1, until a predetermined time elapses after an AP registration/deletion key is inputted, the next registration or deletion is not performed from the same terminal 11. Thus, in Embodiment 1, location information is not changed frequently, and stable location information management can be realized. The above-mentioned data transmit control (enable/inhibit) information may include a signal indicating whether or not registration/deletion of location information has been executed. Thus, the execution result on the terminal 11 side can be notified.

When the timer 46 acquires a timer set request from the data transmit control signal generating unit 45, the timer 46 notifies the data transmit control signal generating unit 45 of the time at that instant. In Embodiment 1, the execution time of each process in the location estimation server 13 may be managed on the basis of time information obtained from the timer 46.

The terminal location information generating unit 47 generates location information of the terminal 11 on the basis of the MAC address of the terminal 11 obtained by the terminal location estimating unit 43, and location information obtained from the location estimation data table 44, and outputs the generated location information to the data transmitting unit 48.

The data transmitting unit 48 outputs data transmit control information (enable/inhibit) information obtained from the data transmit control signal generating unit 45, and terminal location information obtained from the terminal location information generating unit 47 to the terminal 11 that has made a location information request or a registration/deletion request. The data transmitting unit 48 causes these pieces of information to be transmitted to the corresponding terminal 11 via the radio communication unit 40.

<Example Criteria for Determining Registration/Deletion>

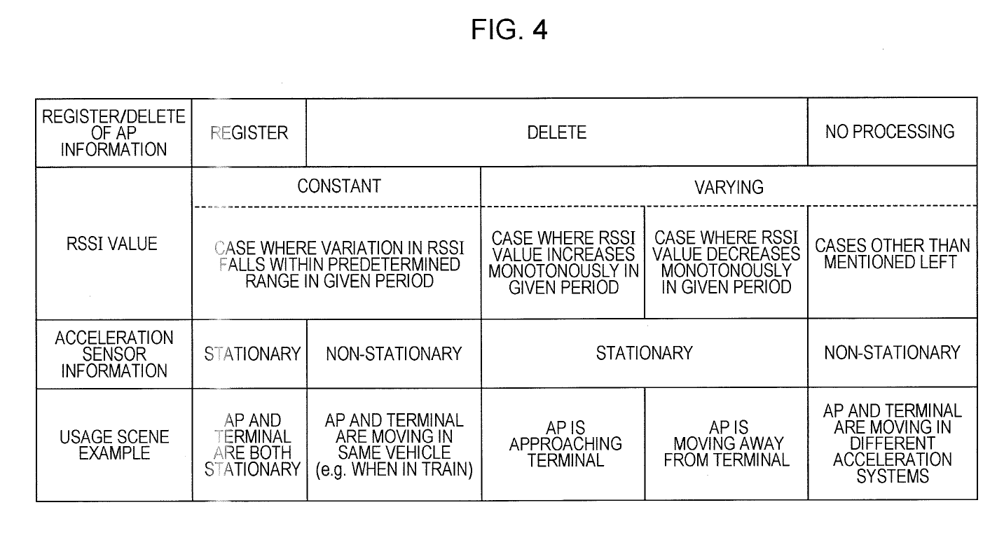

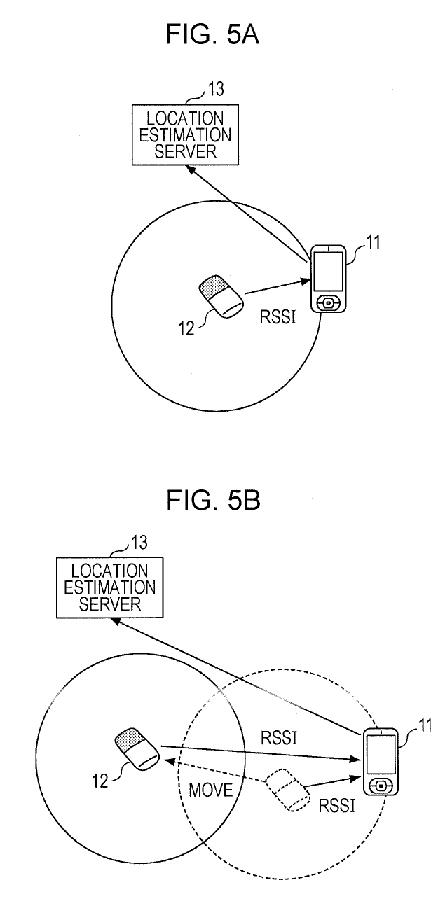

Next, example criteria for determining whether to register/delete AP information in the terminal movement determining unit 26 according to Embodiment 1 is described in detail with reference to FIG. 4 and FIGS. 5A and 5B. FIG. 4 illustrates an example of the criteria for determining whether to register/delete AP information according to Embodiment 1. FIGS. 5A and 5B illustrate states when AP information is registered and deleted, respectively. FIG. 4 illustrates a case in which whether or not it is possible to register/delete AP information is determined on the basis of RSSI information from a mobile AP (mobile router), and the degree of change in acceleration sensor information about the terminal 11. FIG. 5A illustrates the positional relationship when registering AP information, and FIG. 5B illustrates the positional relationship when deleting AP information.

As the criteria for determining registration/deletion, the terminal movement determining unit 26 registers location information or the like of the AP 12 in a case where, for example, the RSSI value is constant (for example, in a case where, as illustrated as FIG. 5A, the variation in RSSI value falls within a predetermined range in a given period owing to a constant distance between the terminal 11 and AP 12), and acceleration sensor information indicates a stationary state. A conceivable example of such a usage scene is, for example, when the AP 12 and the terminal 11 are both in a stationary state.

That is, in Embodiment 1, in a case where the RSSI value received from the AP 12 is a constant value, location information of the terminal 11 and location information of the AP 12 are regarded to be the same, and the location information of the terminal 11 is registered as the location information of the AP 12.

The terminal movement determining unit 26 deletes location information or the like of the AP 12 in a case where the RSSI value is with in a range, and acceleration sensor information indicates a non-stationary state. A conceivable example of such a usage scene is, for example, when the AP 12 and the terminal 11 are moving in the same vehicle such as when in a train. In this case, although the AP 12 and the terminal 11 are both moving (non-stationary), since their relative location does not change, the RSSI value becomes constant.

The terminal movement determining unit 26 deletes location information or the like of the AP 12 in a case where the RSSI value varies (for example, the RSSI value increases monotonously or the RSSI value decreases monotonously in a given period), and acceleration sensor information indicates a stationary state. A conceivable example of such a usage scene is, for example, when the AP 12 is approaching the terminal 11, or when the AP 12 is moving away from the terminal 11 as illustrated as FIG. 5B.

Further, the terminal movement determining unit 26 does not perform any processing in a case where the RSSI value varies as mentioned above, and the RSSI value varies in a manner other than a monotonous increase or monotonous decrease in a given period, and further acceleration sensor information indicates a non-stationary state. A conceivable example of such a usage scene is, for example, when the AP 12 and the terminal 11 are moving in different acceleration systems.

In this way, the terminal movement determining unit 26 determines whether or not it is possible to register/delete AP information more appropriately by determining the variation in RSSI value in a predetermined period, and whether the acceleration sensor information obtained from the average acceleration calculating unit 25 indicates a stationary state or a non-stationary state.

<Specific Examples of AP Registration/Deletion Request Information from the Terminal 11 and Location Estimation Data Table 44>

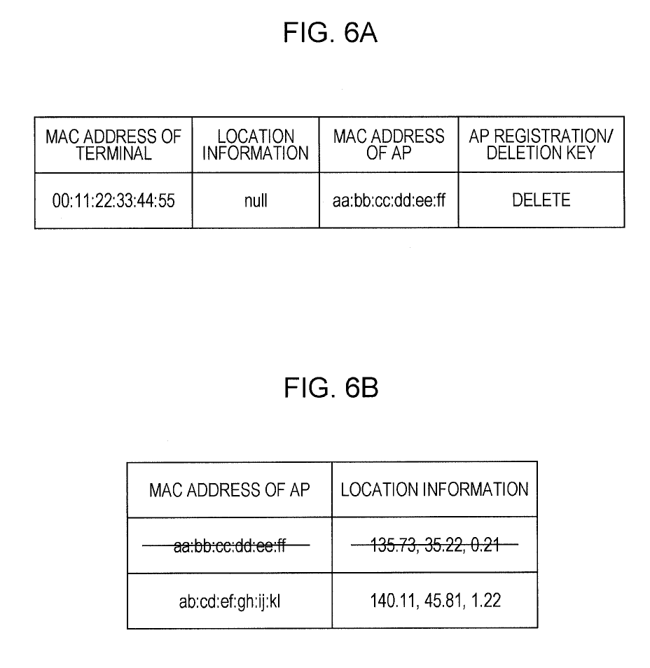

Next, specific examples of AP registration/deletion request information from the terminal 11 and location estimation data table 44 are described with reference to FIGS. 6A and 6B. FIGS. 6A and 6B illustrate specific examples of registration/deletion request information and location estimation data table 44 according to Embodiment 1. FIG. 6A illustrates an example of AP registration/deletion request information, and FIG. 6B illustrates an example of the location estimation data table 44.

As AP registration/deletion request information from the terminal 11, for example, as illustrated as FIG. 6A, items such as the MAC address of the terminal 11, location information, the MAC address of the AP 12, and AP registration/deletion key are set. The details of items included in the AP registration/deletion request information, their order, and data length are not limited to this.

The location information of the terminal 11 in FIG. 6A is set to “null” because “DELETE (deletion)” is set in the AP registration/deletion key and thus location information is not necessary. Accordingly, a value other than “null” may be set in the location information. In Embodiment 1, when “WRITE (registration)” is set in the AP registration/deletion key, for example, a three-dimensional coordinate system or the like is set in the location information. In Embodiment 1, the location information is not limited to the above example. For example, an address, a postal code, or the like may be acquired from three-dimensional coordinates by referring to an address table or the like, and set in the location information. Alternatively, facilities information, building name, shop name, or the like corresponding to the three-dimensional coordinates may be set in the location information.

In the location estimation data table 44 according to Embodiment 1, as illustrated as FIG. 6B, items such as the MAC address of the AP 12 and location information are set. AP registration/deletion or the like is set in the location estimation data table 44. The details of items included in the location estimation data table 44, their order, and data length are not limited to this.

In the example in FIG. 6B, processing corresponding to the registration/deletion request information illustrated as FIG. 6A is performed. That is, in the example in FIG. 6B, deletion “DELETE” is designated for the AP 12 with a MAC address “aa:bb:cc:dd:ee:ff”. Thus, in the location estimation data table 44, location information “135.73, 35.22, 0.21” for the MAC address “aa:bb:cc:dd:ee:ff” is deleted as illustrated as FIG. 6B.

In this way, in Embodiment 1, location information or the like can be registered to or deleted from the location estimation data table 44 on the basis of the value of AP registration/deletion key received by the location estimation server 13 from the terminal 11.

<Processing in the Terminal 11 and the Location Estimation Server 13 According to Embodiment 1>

The processing in the terminal 11 and the location estimation server 13 according to Embodiment 1 mentioned above is described in detail with reference to a flowchart.

<Terminal 11: RSSI Value Variation Determining Process>

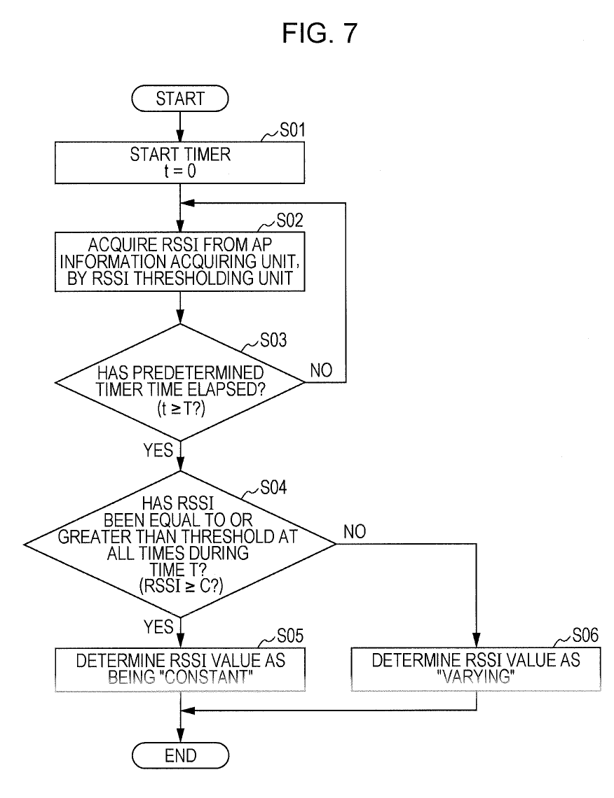

FIG. 7 is a flowchart illustrating an example of a RSSI value variation determining process in the terminal 11 according to Embodiment 1. In the example illustrated as FIG. 7, first, a timer based on the timer 28 is started after being initialized (t=0) (S01). Then, the RSSI thresholding unit 23 acquires RSSI from the AP information acquiring unit 22 (S02).

At this time, the RSSI thresholding unit 23 determines whether or not a predetermined timer time has elapsed (t≧T?) (S03). If a predetermined timer time has not elapsed (NO in S03), until the predetermined time elapses, the RSSI thresholding unit 23 returns to the processing in S02, and performs the subsequent processing. If a predetermined timer time has elapsed (YES in S03), the RSSI thresholding unit 23 determines whether or not the RSSI has been equal to or greater than a threshold (RSSI≧C?) at all times during the period of time T (S04). In the processing in S04, the RSSI thresholding unit 23 may determine whether or not the RSSI has been below a threshold at all times.

If it is determined in the processing in S04 that the RSSI has been equal to or greater than a threshold at all times (YES in S04), the RSSI thresholding unit 23 determines the RSSI value as being “constant” (S05). If it is determined in the processing in S04 that the RSSI has not been equal to or greater than a threshold at all times (NO in S04), the RSSI thresholding unit 23 determines the RSSI value as being “varying” (S06).

<Terminal 11: Movement Determining Process>

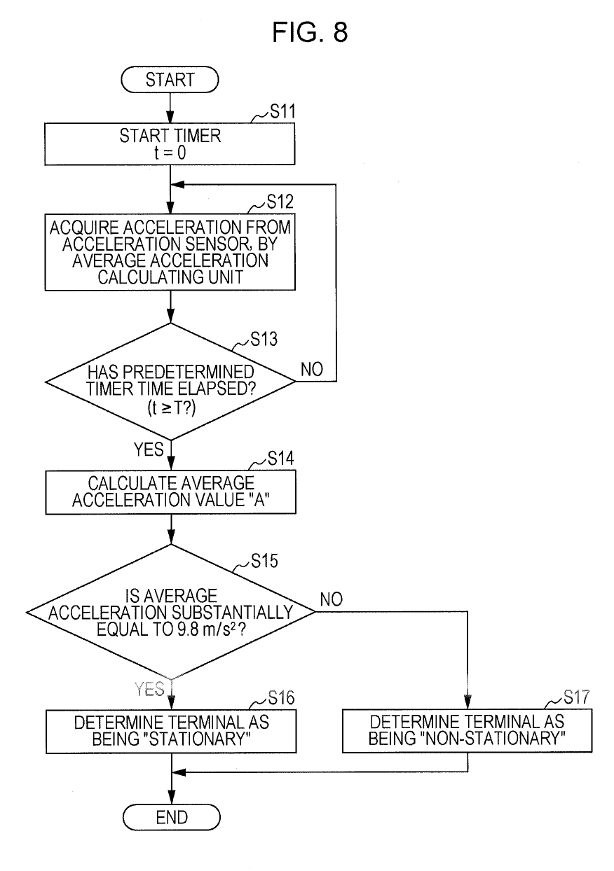

FIG. 8 is a flowchart illustrating an example of a movement determining process in the terminal 11 according to Embodiment 1. In the example illustrated as FIG. 8, first, a timer based on the timer 28 is started after being initialized (t=0) (S11). Then, the average acceleration calculating unit 25 acquires acceleration from the acceleration sensor 24 (S12).

At this time, the average acceleration calculating unit 25 determines whether or not a predetermined timer time has elapsed (t≧T?) (S13). If a predetermined timer time has not elapsed (NO in S13), until the predetermined time elapses, the average acceleration calculating unit 25 returns to the processing in S12, and performs the subsequent processing. If a predetermined timer time has elapsed (YES in S13), the average acceleration calculating unit 25 calculates an average acceleration value A (S14).

Next, the terminal movement determining unit 26 determines whether or not the average acceleration is substantially equal to 9.8 m/s² (S15). The expression “substantially equal to 9.8 m/s²” refers to a value including 9.8±α, and the value of α varies in accordance with, for example, the performance of the acceleration sensor 24, the time interval until the acceleration average is calculated, and other conditions or the like.

If it is determined in the processing in S15 that the acceleration average is substantially equal to 9.8 m/s² (YES in S15), the terminal movement determining unit 26 determines the terminal 11 as being “stationary” (S16). If it is determined in the processing in S15 that the acceleration average is not substantially equal to 9.8 m/s² (NO in S15), the terminal movement determining unit 26 determines the terminal 11 as being “non-stationary” (S17).

<Terminal 11: AP Information Transmitting Process>

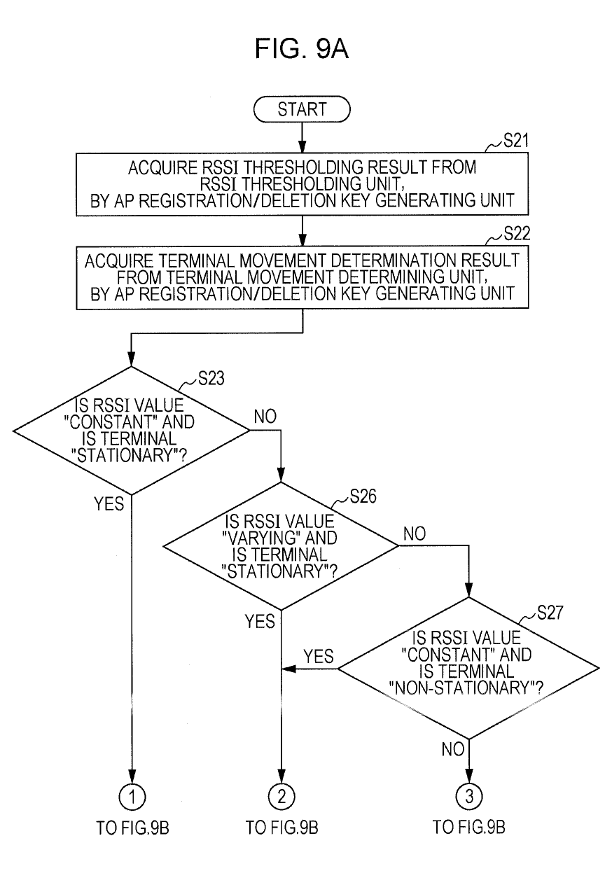

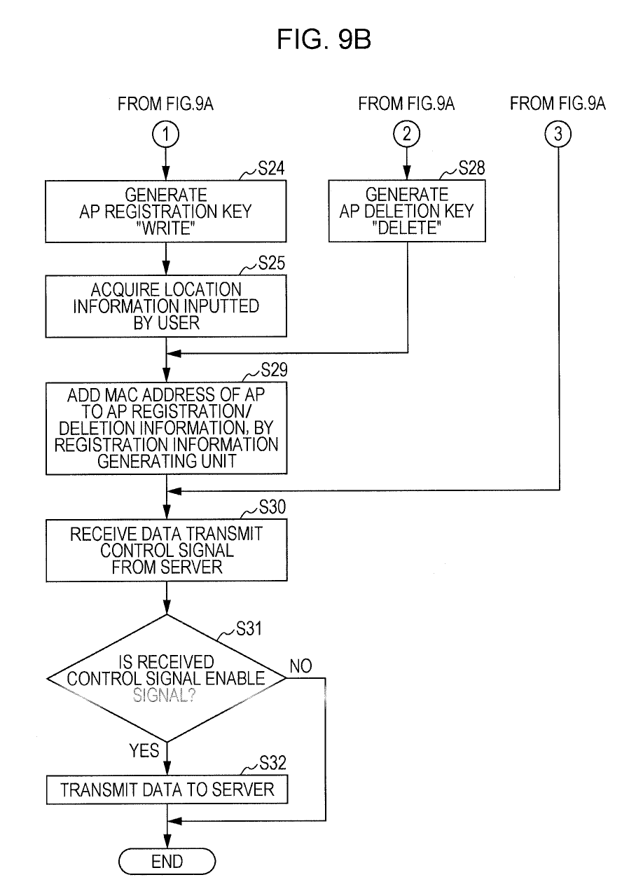

FIGS. 9A and 9B are each a flowchart illustrating an example of an AP information transmitting process in the terminal 11 according to Embodiment 1. In the example illustrated as FIGS. 9A and 9B, first, the AP registration/deletion key generating unit 27 acquires the RSSI thresholding result from the RSSI thresholding unit 23 (S21). The AP registration/deletion key generating unit 27 also acquires the terminal movement determination result from the terminal movement determining unit 26 (S22).

At this time, the AP registration/deletion key generating unit 27 determines whether the RSSI value is “constant” and the terminal 11 is “stationary” (S23). If the RSSI value is “constant” and the terminal 11 is “stationary” (YES in S23), the AP registration/deletion key generating unit 27 generates an AP registration key “WRITE” (S24). Also, the location information input unit 29 acquires location information inputted by the user (S25).

If it is determined in the processing in S23 that the RSSI value is not “constant” and the terminal 11 is not “stationary” (NO in step S23), next, the AP registration/deletion key generating unit 27 determines whether or not the RSSI value is “varying” and the terminal 11 is “stationary” (S26). At this time, if the RSSI value is not “varying” and the terminal 11 is not “stationary” (NO in S26), next, the AP registration/deletion key generating unit 27 determines whether or not the RSSI value is “constant” and the terminal 11 is “non-stationary” (S27).

If it is determined in the processing in S26 mentioned above that the RSSI value is “varying” and the terminal 11 is “stationary” (YES in step S26), or if it is determined in the processing in S27 that the RSSI value is “constant” and the terminal 11 is “non-stationary” (YES in step S27), the AP registration/deletion key generating unit 27 generates an AP deletion key “DELETE” (S28).

After the end of the processing in S25 and S28, the registration information generating unit 30 adds the MAC address of the AP 12 to the AP registration/deletion information. After the end of the processing in S29, or if it is determined in the processing in step S27 that the RSSI value is not “constant” and the terminal 11 is not “non-stationary” (NO in S27), the AP registration/deletion key generating unit 27 receives a data transmit control signal from the location estimation server 13 (S30).

Next, the AP registration/deletion key generating unit 27 determines whether or not the received control signal is an enable signal (S31). If the received control signal is an enable signal (YES in S31), the AP registration/deletion key generating unit 27 transmits data to the location estimation server 13 (S32), and ends the processing. If the received control signal is not an enable signal (NO in S31), the AP registration/deletion key generating unit 27 ends the processing without performing anything.

<Location Estimation Server 13: Location Information Transmitting Process>

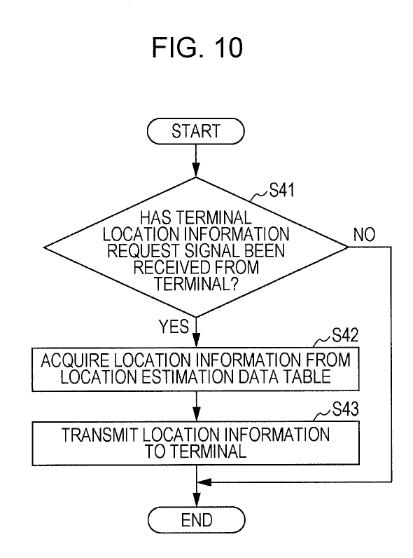

FIG. 10 is a flowchart illustrating an example of a location information transmitting process in the location estimation server 13 according to Embodiment 1. In the example illustrated as FIG. 10, first, the data transmitting unit 41 determines whether or not a request signal for terminal location information has been received from the terminal 11 (S41). If a request signal for terminal location information has been received (YES in S41), the terminal location estimating unit 43 acquires location information corresponding to the MAC address of the AP 12 included in the request signal from the location estimation data table 44 (S42), transmits the acquired location information to the terminal 11 (S43), and ends the processing.

If it is determined in the processing in S41 that a request signal for terminal location information has not been received from the terminal 11 (NO in S41), the processing is ended without performing anything.

<Location Estimation Server 13: AP Information Registration/Deletion Process>

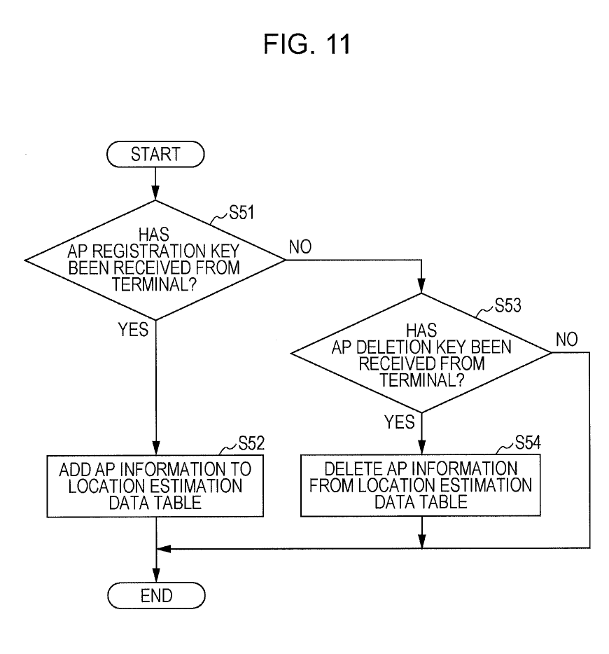

FIG. 11 is a flowchart illustrating an example of an AP information registration/deletion process in the location estimation server 13 according to Embodiment 1. In the example illustrated as FIG. 11, first, the terminal location estimating unit 43 determines whether or not an AP registration key has been received from the terminal 11 (S51). If an AP registration key has been received (YES in S51), the terminal location estimating unit 43 adds AP information related to the requested AP to the location estimation data table 44 (S52), and ends the processing.

If it is determined in the processing in S51 that an AP registration key has not been received (NO in S51), the terminal location estimating unit 43 determines whether or not an AP deletion key has been received (S53). At this time, if an AP deletion key has been received (YES in S53), the terminal location estimating unit 43 deletes AP information related to the requested AP from the location estimation data table 44 (S54), and ends the processing.

If it is determined in the processing in S53 that an AP deletion key has been not received (NO in S53), the terminal location estimating unit 43 ends the processing without performing anything.

<Location Estimation Server 13: Data Transmit Control Signal Generating Process>

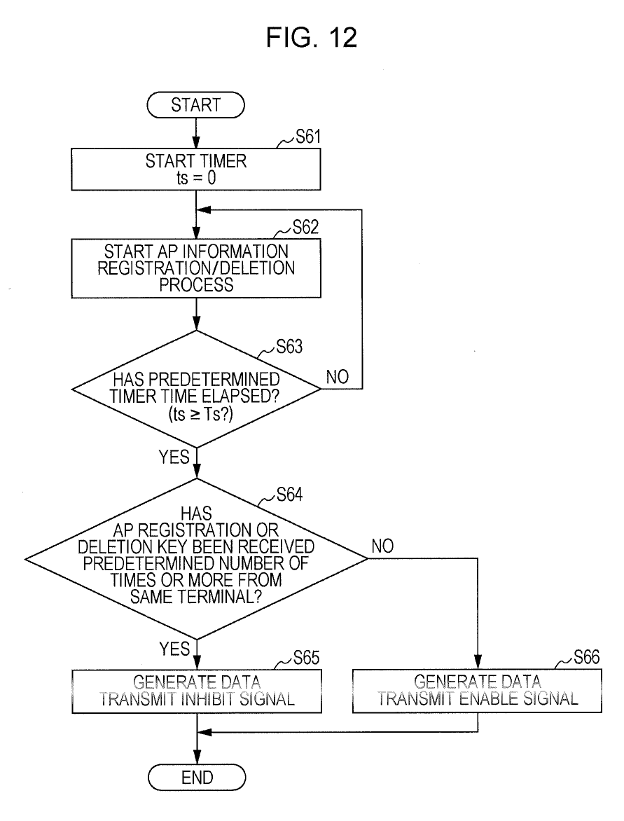

FIG. 12 is a flowchart illustrating an example of a data transmit control signal generating process in the location estimation server 13 according to Embodiment 1. In the example illustrated as FIG. 12, first, a timer based on the timer 46 is started after being initialized (ts=0) (S61). Then, the data transmit control signal generating unit 45 starts the AP information registration/deletion process mentioned above (S62).

After the processing in S62, the data transmit control signal generating unit 45 determines whether or not a predetermined timer time has elapsed (ts≧Ts?) (S63). If a predetermined timer time has not elapsed (NO in S63), the data transmit control signal generating unit 45 returns to the processing in S62, and performs the subsequent processing. If a predetermined timer time has elapsed (YES in S63), the data transmit control signal generating unit 45 determines whether or not an AP registration or deletion key has been received a predetermined number of times (for example, three times, five times, or ten times) or more from the same terminal (S64).

At this time, if an AP registration or deletion key has been received a predetermined number of times or more from the same terminal (YES in S64), the data transmit control signal generating unit 45 generates a data transmit inhibit signal (S65). If an AP registration or deletion key has not been received a predetermined number of times or more from the same terminal (NO in S64), the data transmit control signal generating unit 45 generates a data transmit enable signal (S66). It is thus possible to reduce frequent registrations or deletions of AP location information.

### Embodiment 2

Next, Embodiment 2 is described. In Embodiment 1 described above, when registering location information of the AP 12 to the location estimation server 13 by using the terminal 11, the location information is acquired by a user's manual input. In Embodiment 2, the location information is acquired by using other APs 12.

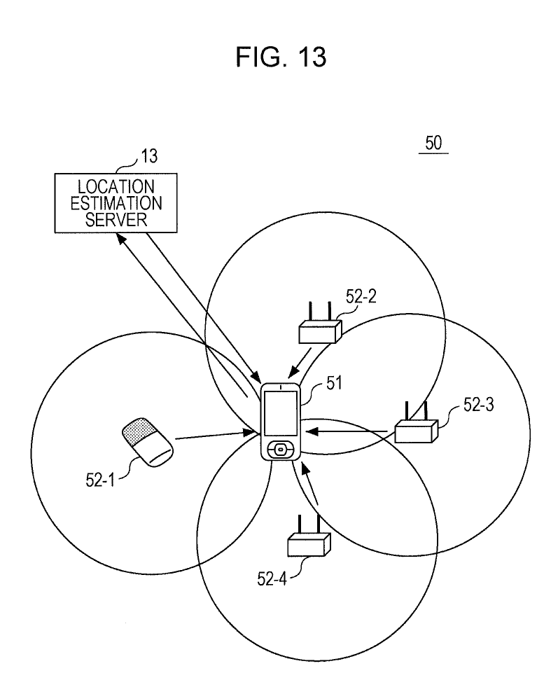

FIG. 13 illustrates an example of the schematic configuration of a location estimation system according to Embodiment 2. A location estimation system 50 illustrated as FIG. 13 has a terminal 51, APs 52-1 to 52-4, and a location estimation server 13. In the example illustrated as FIG. 13, the AP 52-1 is, for example, a mobile AP, and the APs 52-2 to 52-4 are, for example, fixed APs.

In Embodiment 2, as illustrated as FIG. 13, the terminal 51 acquires RSSI from the AP 52-1. At this time, when performing registration of AP information for the AP 52-1 on the basis of the obtained RSSI, in the terminal 51, location information of the terminal 51 is acquired on the basis of the result of trilateration using the other APs 52-2 to 52-4, and the acquired location information of the terminal 51 is inputted as location information of the mobile AP 52-1. Therefore, in Embodiment 2, the input operation of location information itself can be automated, and also the accuracy of AP registration can be further improved. In Embodiment 2, as in Embodiment 1, the terminal 51 can be also used to delete AP information of the AP 52-1.

<Block Configuration Example of the Terminal 51>

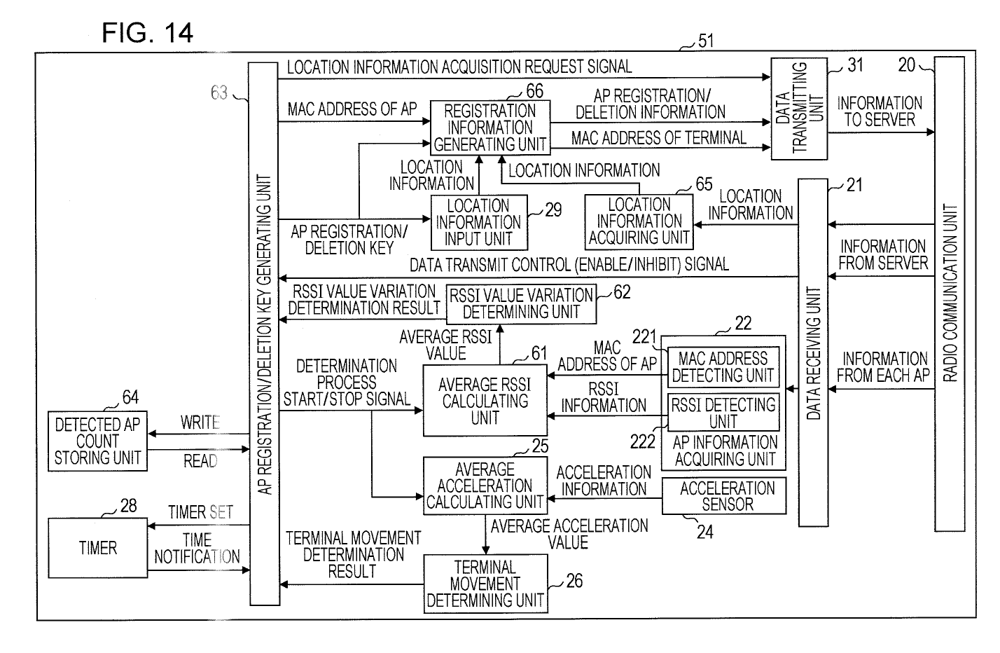

Now, a block configuration example of the terminal 51 according to Embodiment 2 is described in detail with reference to FIG. 14. In the following description, blocks for performing the same processing as those in the block configuration of the terminal 11 according to Embodiment 1 described above are denoted by the same reference numerals, and a detailed description of such blocks is omitted here.

FIG. 14 illustrates an example of the block configuration of the terminal 51 according to Embodiment 2. The terminal 51 illustrated as FIG. 14 has a radio communication unit 20, a data receiving unit 21, an AP information acquiring unit 22, an acceleration sensor 24, an average acceleration calculating unit 25, a terminal movement determining unit 26, a timer (clocking unit) 28, a location information input unit 29, a data transmitting unit 31, an average RSSI calculating unit 61, a RSSI value variation determining unit 62, an AP registration/deletion key generating unit 63, a detected AP count storing unit 64, a location information acquiring unit 65, and a registration information generating unit 66.

The terminal 51 according to Embodiment 2 does not have the RSSI thresholding unit 23 according to Embodiment 1, and has the average RSSI calculating unit 61, the RSSI value variation determining unit 62, and the detected AP count storing unit 64.

The average RSSI calculating unit 61 acquires the MAC addresses of individual APs and RSSI information corresponding to the individual APs obtained from the AP information acquiring unit 22, for a predetermined period of time, and calculates the average of the acquired RSSIs of the individual APs. Also, the average RSSI calculating unit 61 outputs the acquired average RSSI value to the RSSI value variation determining unit 62.

The RSSI value variation determining unit 62 outputs the RSSI value variation determination result to the AP registration/deletion key generating unit 63 on the basis of the average RSSI value obtained from the average RSSI calculating unit 61.

The AP registration/deletion key generating unit 63 outputs a start/stop signal for a determination process to each of the average RSSI calculating unit 61 and the average acceleration calculating unit 25. Also, the AP registration/deletion key generating unit 63 performs registration or deletion, or the like of AP information (location information or the like) for the AP 52-1, on the basis of the RSSI value variation determination result obtained from the RSSI value variation determining unit 62 and the terminal movement determination result obtained from the terminal movement determining unit 26. While the determination as to whether to register or delete AP information can be made on the basis of, for example, the determination criteria as illustrated as FIG. 4 described above, the method of determination is not limited to this. Also, on the basis of the result of determination as to whether to register or delete AP information, the AP registration/deletion key generating unit 63 sets an AP registration key (WRITE) or AP deletion key (DELETE).

The AP registration/deletion key generating unit 63 writes the acquired RSSI value variation determination result to the detected AP count storing unit 64. Also, the AP registration/deletion key generating unit 63 reads information stored in the detected AP count storing unit 64, and determines whether or not four or more APs have been detected. The four or more APs include one AP whose location is to be registered (for example, the AP 52-1), and three APs for performing trilateration (for example, the APs 52-2 to 52-4). In Embodiment 2, when selecting the three APs for performing positioning, for example, three APs are selected in order of highest RSSI from among a plurality of pieces of data stored in the detected AP count storing unit 64.

Further, the AP registration/deletion key generating unit 63 outputs a location information acquisition request signal to the location estimation server 13. At this time, a reply to the location information acquisition request signal obtained from the location estimation server 13 is acquired by the location information acquiring unit 65.

The detected AP count storing unit 64 stores information such as the number of APs detected by the terminal 51, the RSSI value variation determination result, and MAC address, and these pieces of information are read out to the AP registration/deletion key generating unit 63 as appropriate.

The location information acquiring unit 65 outputs location information acquired by trilateration to the registration information generating unit 66. Also, the location information acquiring unit 65 acquires, from the location estimation server 13, location information obtained as a reply corresponding to a location information acquisition request.

The registration information generating unit 66 can generate registration information by using the location information acquired by the location information acquiring unit 65, in addition to the input of location information from the location information input unit 29 as described in Embodiment 1.

As described above, in Embodiment 2, when generating AP registration information, estimation of terminal location by trilateration is used in combination. That is, in Embodiment 2, when four or more APs are detected, location information acquired not by a manual input but by trilateration is transmitted to the location estimation server 13, thereby automating the input operation of location information itself and further improving the accuracy of mobile AP registration.

Since the block configuration of the location estimation server 13 according to Embodiment 2 is the same as the block configuration of the location estimation server 13 according to Embodiment 1, a detailed description of the block configuration is omitted here.

<Specific Examples of AP Registration/Deletion Request Information from the Terminal 51 and Location Estimation Data Table 44>

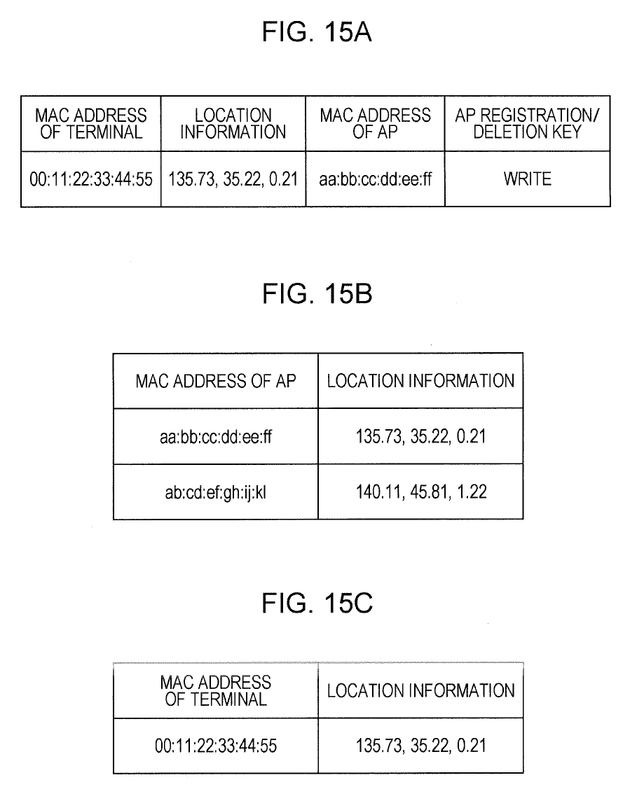

Next, specific examples of AP registration/deletion request information from the terminal 51 and location estimation data table 44 are described with reference to FIGS. 15A to 15C. FIGS. 15A to 15C illustrate specific examples of registration/deletion request information and location estimation data table 44 according to Embodiment 2. FIG. 15A illustrates an example of AP registration/deletion request information, FIG. 15B illustrates an example of the location estimation data table 44, and FIG. 15C illustrates an example of information transmitted to the terminal 51.

FIG. 15A illustrates registration/deletion request information including the same items as those in Embodiment 1 described above (FIG. 6A). In the example illustrated as FIG. 15A, “WRITE” is set in the AP registration/deletion key. Thus, AP information including location information “135.73, 35.22, 0.21” and the MAC address of the AP 52-1 is registered to the location estimation data table 44 (FIG. 15B). The location information to be registered includes location information acquired by trilateration.

Therefore, in Embodiment 2, when a location information acquisition request is made from the terminal 51, for example, terminal location information obtained by trilateration can be acquired from the location estimation data table 44, and the acquired information (FIG. 15C) can be transmitted to the terminal 51.

In Embodiment 2, in the case of deleting AP information, for example, “null” is set in the location information of the registration/deletion request information illustrated as FIG. 15A, and “DELETE (deletion)” is set in the AP registration/deletion key.

In this way, in Embodiment 2, as in Embodiment 1, AP information (location information) can be registered to or deleted from the location estimation data table 44 on the basis of the value of AP registration/deletion key received by the location estimation server 13 from the terminal 51. Moreover, in Embodiment 2, as location information, not information acquired by a manual input by the user of the terminal 51 but location information acquired by trilateration using other APs 52-2 to 52-4 can be used. Thus, the accuracy of location information registration can be improved.

<Processing in the Terminal 51 and the Location Estimation Server 13 According to Embodiment 2>

The processing in the terminal 51 and the location estimation server 13 according to Embodiment 2 mentioned above is described in detail with reference to a flowchart.

<Terminal 51: RSSI Value Variation Determining Process>

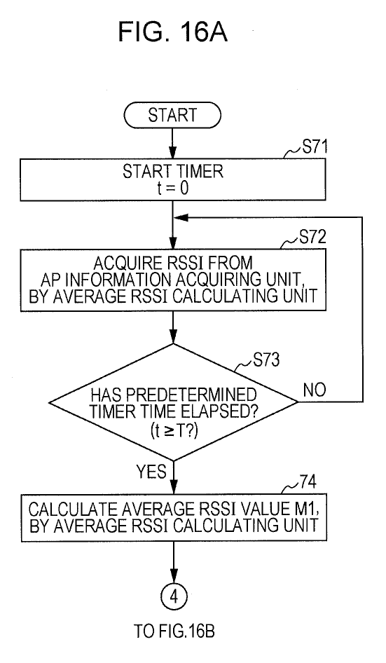

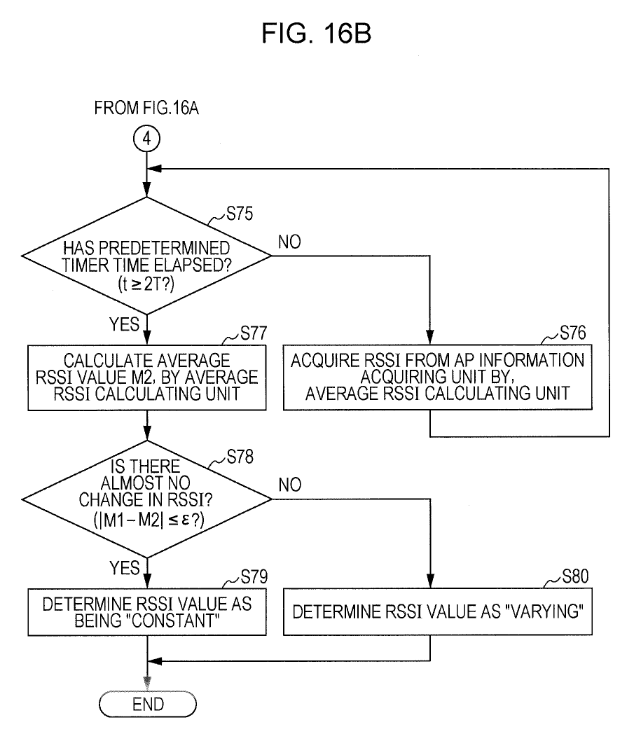

FIGS. 16A and 16B are each a flowchart illustrating an example of a RSSI value variation determining process in the terminal 51 according to Embodiment 2. In the example illustrated as FIGS. 16A and 16B, first, a timer based on the timer 28 is started after being initialized (t=0) (S71). Then, the average RSSI calculating unit 61 acquires RSSI from the AP information acquiring unit 22 (S72).

At this time, the average RSSI calculating unit 61 determines whether or not a predetermined timer time has elapsed (t≧T?) (S73). If a predetermined timer time has not elapsed (NO in S73), until the predetermined time elapses, the average RSSI calculating unit 61 returns to the processing in S72, and performs the subsequent processing. If a predetermined timer time has elapsed (YES in S73), the average RSSI calculating unit 61 calculates an average RSSI value M1 (S74).

Next, the average RSSI calculating unit 61 determines whether or not a predetermined timer time has further elapsed since the calculation of M1 (t≧2T?) (S75). If a predetermined timer time has not elapsed (NO in S75), as in the processing in S72, the average RSSI calculating unit 61 acquires RSSI from the AP information acquiring unit 22 (S76), and thereafter returns to the processing in S72. If it is determined in the processing in S75 that a predetermined timer time has elapsed (YES in S75), the average RSSI calculating unit 61 calculates an average value M2 of RSSI acquired within a predetermined time after M1 is calculated (S77).

Thereafter, the RSSI value variation determining unit 62 determines whether or not there is almost no change in RSSI (S78). Specifically, for example, it is determined whether or not the absolute value |M1−M2| of the difference between the average values M1 and M2 is equal to or less than a threshold ε (|M1−M2|≦ε).

At this time, if it is determined in the processing in S78 that there is almost no change in RSSI (YES in S78), the RSSI value variation determining unit 62 determines the RSSI value as being “constant” (S79). If there is a change in RSSI (NO in S78), the RSSI value variation determining unit 62 determines the RSSI value as being “varying” (S80).

<Terminal 51: Movement Determining Process>

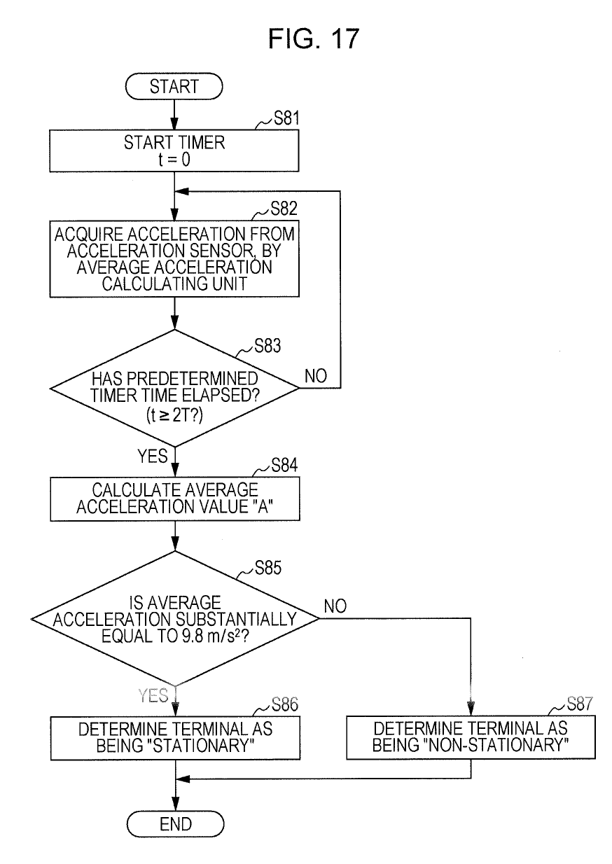

FIG. 17 is a flowchart illustrating an example of a movement determining process in the terminal 51 according to Embodiment 2. In the example illustrated as FIG. 17, first, a timer based on the timer 28 is started after being initialized (t=0) (S81). Then, the average acceleration calculating unit 25 acquires acceleration from the acceleration sensor 24 (S82).

At this time, the average acceleration calculating unit 25 determines whether or not a predetermined timer time has elapsed (t≧2T?) (S83). The predetermined time used in the determination in S83 is the above-mentioned predetermined time 2T used when calculating the average RSSI value M2.

If it is determined in the processing in S83 that a predetermined timer time has not elapsed (NO in S83), until the predetermined time elapses, the average acceleration calculating unit 25 returns to the processing in S82, and performs the subsequent processing. If a predetermined timer time has elapsed (YES in S83), the average acceleration calculating unit 25 calculates an average acceleration value A (S84).

Next, the terminal movement determining unit 26 determines whether or not the average acceleration is substantially equal to 9.8 m/s² (S85). As described above, the expression “substantially equal to 9.8 m/s²” refers to a value including 9.8±α.

If it is determined in the processing in S85 that the acceleration average is substantially equal to 9.8 m/s² (YES in S85), the terminal movement determining unit 26 determines the terminal 51 as being “stationary” (S86). If it is determined in the processing in S85 that the acceleration average is not substantially equal to 9.8 m/s² (NO in S85), the terminal movement determining unit 26 determines the terminal 51 as being “non-stationary” (S87).

<Terminal 51: AP Information Transmitting Process>

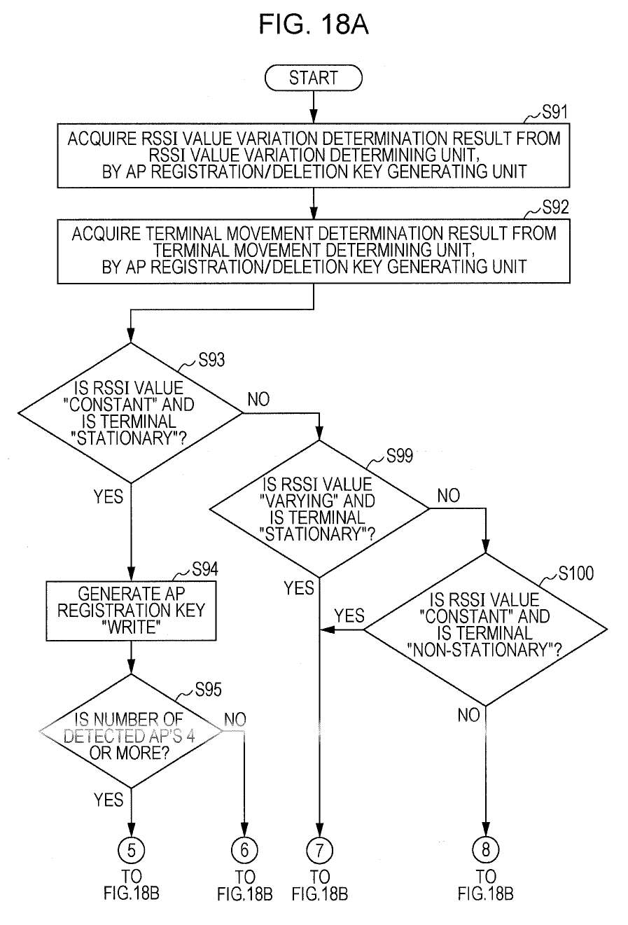

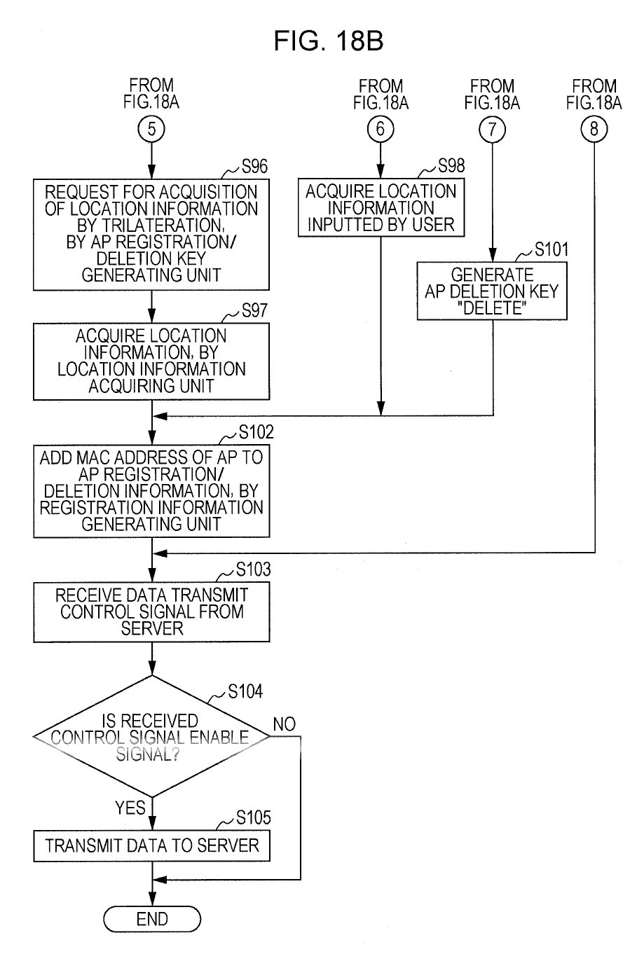

FIGS. 18A and 18B are each a flowchart illustrating an example of an AP information transmitting process in the terminal 51 according to Embodiment 2. In the example illustrated as FIGS. 18A and 18B, first, the AP registration/deletion key generating unit 63 acquires the RSSI value variation determination result from the RSSI value variation determining unit 62 (S91). The AP registration/deletion key generating unit 63 also acquires the terminal movement determination result from the terminal movement determining unit 26 (S92).

At this time, the AP registration/deletion key generating unit 63 determines whether the RSSI value is “constant” and the terminal 51 is “stationary” (S93). If the RSSI value is “constant” and the terminal 51 is “stationary” (YES in S93), the AP registration/deletion key generating unit 63 generates an AP registration key “WRITE” (S94).

Also, the AP registration/deletion key generating unit 63 refers to the detected AP count storing unit 64, and determines whether or not the number of detected APs is 4 or more (S95). At this time, if the number of detected APs is 4 or more (YES in S95), the AP registration/deletion key generating unit 63 makes a request for acquisition of location information by trilateration (S96). Thus, the location information acquiring unit 65 acquires location information (S97). If the number of detected APs is not 4 or more (NO in S95), the location information input unit 29 acquires location information inputted by the user (S98).

If it is determined in the processing in S93 that the RSSI value is not “constant” and the terminal 51 is not “stationary” (NO in step S93), next, the AP registration/deletion key generating unit 63 determines whether or not the RSSI value is “varying” and the terminal 51 is “stationary” (S99). At this time, if the RSSI value is not “varying” and the terminal 51 is not “stationary” (NO in S99), next, the AP registration/deletion key generating unit 63 determines whether or not the RSSI value is “constant” and the terminal 51 is “non-stationary” (S100).

If it is determined in the processing in S99 mentioned above that the RSSI value is “varying” and the terminal 51 is “stationary” (YES in step S99), or if it is determined in the processing in S100 that the RSSI value is “constant” and the terminal 51 is “non-stationary” (YES in step S100), the AP registration/deletion key generating unit 63 generates an AP deletion key “DELETE” (S101).

After the end of the processing in S97, S98, and S101, the registration information generating unit 66 adds the MAC address of the AP 52-1 to the AP registration/deletion information. Also, after the end of the processing in S102, or if it is determined in the processing in step S100 that the RSSI value is not “constant” and the terminal 51 is not “non-stationary” (NO in S100), the AP registration/deletion key generating unit 63 receives a data transmit control signal from the location estimation server 13 (S103).

Next, the AP registration/deletion key generating unit 63 determines whether or not the received control signal is an enable signal (S104). If the received control signal is an enable signal (YES in S104), the AP registration/deletion key generating unit 63 transmits data to the location estimation server 13 (S105), and ends the processing. If the received control signal is not an enable signal (NO in S104), the AP registration/deletion key generating unit 63 ends the processing without performing anything.

<Location Estimation Server 13: AP Information Registration/Deletion Process>

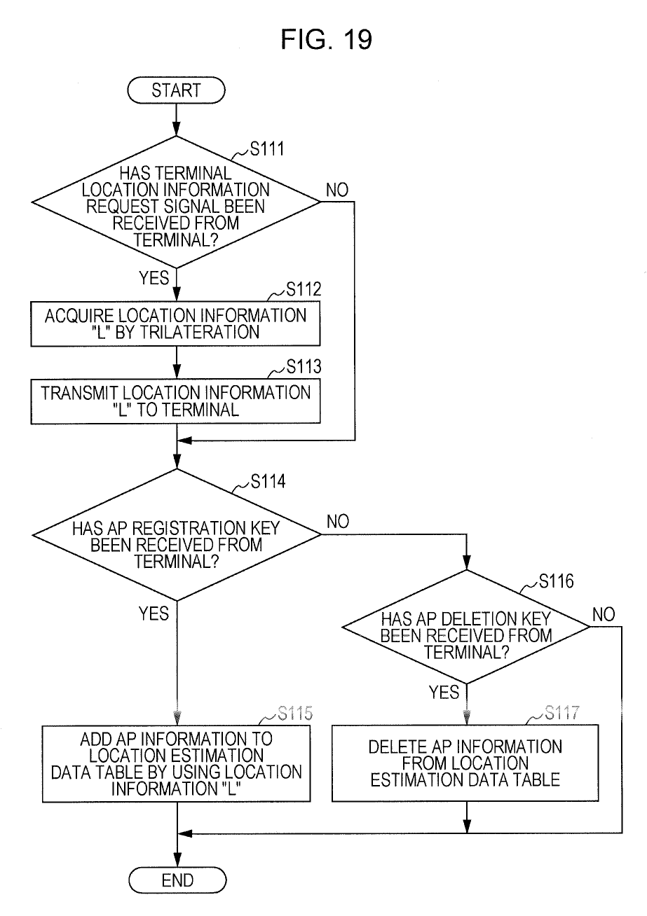

FIG. 19 is a flowchart illustrating an example of an AP information registration/deletion process in the location estimation server 13 according to Embodiment 2. FIG. 19 illustrates a case in which AP information is added to the location estimation data table 44 by using location information transmitted to the terminal 51.

In the example illustrated as FIG. 19, first, the terminal location estimating unit 43 determines whether or not a request signal for terminal location information has been received from the terminal 51 (S111). If a request signal for terminal location information has been received from the terminal 51 (YES in S111), the terminal location estimating unit 43 acquires location information L by trilateration (S112). Also, the terminal location estimating unit 43 transmits the acquired location information L to the terminal 51 (S113).

Next, the terminal location estimating unit 43 determines whether or not an AP registration key has been received from the terminal 51 (S114). If an AP registration key has been received (YES in S114), the terminal location estimating unit 43 adds AP information to the location estimation data table 44 by using the location information L (S115).

If an AP registration key has not been received (NO in S114), the terminal location estimating unit 43 determines whether or not an AP deletion key has been received from the terminal 51 (S116). At this time, if an AP deletion key has been received (YES in S116), the terminal location estimating unit 43 deletes AP information from the location estimation data table 44 (S117), and ends the processing.

If it is determined in the processing in S116 that an AP deletion key has been not received (NO in S116), the terminal location estimating unit 43 ends the processing without performing anything.

In Embodiment 2, other than the processing illustrated as FIG. 19 mentioned above, for example, the location information transmitting process and the AP information registration/deletion process described in Embodiment 1 may be performed separately. Also, as a data transmit control signal generating process in the location estimation server 13 according to Embodiment 2, for example, the same processing as that in Embodiment 1 described above (FIG. 12) can be performed.

As described above, according to Embodiment 2, for example, when registering location information of the AP 52-1, the registration can be performed on the basis of location information obtained by positioning using other APs 52-2 to 52-4. Therefore, registration of location information can be performed with uniform level, without causing differences in self-judgment or the like among individual users. Further, the accuracy of location information registration can be improved by using location information obtained by trilateration.

The embodiments mentioned above can be used in combination as appropriate. Also, while in the above-mentioned embodiments management of registration/deletion or the like of AP information (location information or the like) corresponding to the AP 12, 52-1 is performed by using the terminal 11, 51 and the location estimation server 13, applicable embodiments are not limited to this. For example, location information or the like related to the AP 12, 52-1 may be managed by an information processing apparatus provided with the functions in the terminal 11, 51 mentioned above and the functions in the location estimation server 13. Further, part or all of the functions in the terminal 11, 51 may be included in the location estimation server 13, or part or all of the functions in the location estimation server 13 may be included in the terminal 11, 51. Moreover, the above-mentioned embodiments can reduce cost because an acceleration sensor is not provided to an access point.

The registration/deletion process of AP information described in the above-mentioned embodiments may be implemented as a program to be executed by a computer. By installing this program from a server or the like and executing the program by the computer, the above-mentioned registration/deletion process of AP information can be implemented.

It is also possible to record this program onto a recording medium, and have the recording medium recording this program read by a computer or a terminal to thereby implement the above-mentioned registration/deletion process of AP information. As the recording medium, various types of recording media can be used, including recording media that optically, electrically, or magnetically record information such as a CD-ROM, a flexible disc, and a magneto-optical disc, and semiconductor memories that electrically record information such as a ROM and a flash memory. Also, the registration/deletion process of AP information described in the above-mentioned embodiments may be implemented in a single or plurality of integrated circuits.

While the embodiments have been described above, the embodiments are not limited to specific embodiments. Besides the above-mentioned modifications, various other modifications and alterations are possible within the scope of the appended claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
an information acquirer configured to acquire information transmitted from an access point;
a movement determiner configured to determine whether or not the information processing apparatus is moving; and
a registration deletion determiner configured to determine, based on the acquired information and a result determined by the movement determiner, whether to register or delete information of a location of the access point.

2. The information processing apparatus according to claim 1, wherein
the acquired information includes a receive signal strength indication which is indicative of a strength of a radio wave received from the access point.

3. The information processing apparatus according to claim 2, wherein
the registration deletion determiner determines whether to register or delete the information of the location of the access point, based on a presence or absence of a variation in the receive signal strength indication and a presence or absence of a displacement of the information processing apparatus.

4. The information processing apparatus according to claim 2, wherein
the registration deletion determiner determines that locations of the access point and the information processing apparatus are same when the receive signal strength indication is larger than or equal to a given value.

5. The information processing apparatus according to claim 1, further comprising a location information input unit configured to receive location information when the information inputted by a user when the information of the location of the access point is registered.

6. The information processing apparatus according to claim 1, wherein
the information processing apparatus sends to a location estimation server a request for registration or deletion information of the location of the access point, based on a result whether to register or delete information of the location of the access point, the result being determined by the information processing apparatus, and
the location estimation includes a data table for managing the information of the location of the access point, the data table including information of an identifier and the information of the location of the access point, the information of the identifier and location being resister to or delete from the data table based on the result.

7. The information processing apparatus according to claim 1, wherein the information of the location of the access point is obtained by calculating information of locations of access points more than tow other than the access point.

8. A management method executed by an information processing apparatus, the management method comprising:
acquiring information transmitted from an access point;
determining whether or not the information processing apparatus is moving; and
determining, based on the acquired information and a result in respect to whether or not the information processing apparatus is moving, whether to register or delete information of a location of the access point.

9. A non-transitory computer-readable medium storing a program that causes a computer to execute a procedure comprising:
acquiring, by the computer, information transmitted from an access point;
determining whether or not the information processing apparatus is moving; and
determining, based on the acquired information and a result in respect to whether or not the information processing apparatus is moving, whether to register or delete information of a location of the access point.
